(19) United States
(12) Patent Application Publication
(10) Pub. No.: US 2005/0039816 A1
(43) Pub. Date: Feb. 24, 2005

(54) Vacuum powered method and apparatus for wirelessly handling and conveying granular material

(76) Inventor: Stephen B. Maguire, Glen Mills, PA (US)

Correspondence Address: Charles N. Quinn, Esq.;Fox Rothschild LLP, 10th Floor, 2000 Market Street, Philadelphia, PA, 19103, US

(21) Appl. No.: 10/866,557

(22) Filed: Jun. 12, 2004

Related U.S. Application Data
(60) Provisional application No. 60/480,309, filed on Jun. 20, 2003.

(51) Int. Cl. B67C 3/00

(52) U.S. Cl. 141/8

(57) ABSTRACT

A method for supplying plastics-related granular material to a plurality of receptacles for subsequent processing, such as by molding or extrusion, including applying vacuum to granules of material in a supply depot to draw a granule stream therefrom, drawing said stream past sequentially positioned individual receptacles of said plurality of receptacles and stripping granules from said stream for supply of said plurality of receptacles by passing said stream along a protuberance.

### CROSS-REFERENCE TO RELATED PATENT APPLICATIONS

This patent application claims, under the applicable provisions of 35 USC 119 and 120, the benefit of the filing date of priority of provisional U.S. patent application 60/480,309, entitled “Vacuum Driven Wireless Material Handling System”, filed 20 Jun. 2003 in the name of Stephen B. Maguire.

### BACKGROUND OF THE INVENTION—FIELD OF THE INVENTION

This invention relates to methods and apparatus for transporting granular material, particularly granular plastic resin material.

### BACKGROUND OF THE INVENTION—DESCRIPTION OF THE PRIOR ART

A wide variety of plastic products are fabricated by molding or extrusion. Plastic fabricators operating molding and/or extrusion machines transfer plastic resin material to be molded or extruded from central storage locations to the molding or extrusion machines. The material is generally transferred by a vacuum powered system. Typically in a large facility, a single central conveying system transfers the plastic material to the molding presses and/or to the extruders where the material is molded or extruded into a finished or semi-finished product.

In a large plastics manufacturing facility, the granular plastic resin material conveying system typically uses a single central vacuum pump. A common vacuum line is typically installed in the ceiling of the facility and runs to the location of each molding press and extruder. In a typical large installation there may be twenty (20) molding presses or extruders. Each such molding press and/or extruder typically require three material receptacles located close to each molding press or extruder for temporarily separately storing and then loading (i) natural granular plastic resin material, (ii) re-grind granular plastic resin material and (iii) color material into respective hoppers connected with each molding press or extruder. Hence, a facility operating twenty (20) molding presses or twenty (20) extruders requires sixty (60) hoppers and associated receptacles.

Each receptacle is connected to a material source by a material feed line and is connected to the single center vacuum pump by a vacuum line.

Color material is typically stored adjacent to each molding press or extruder of interest. Re-grind granular plastic resin material, which is material being recycled, is also typically stored close to the molding press or extruder of interest. However, because natural (or virgin—the two terms are used interchangeably herein) granular plastic material constitutes by far the largest component and hence the largest volume furnished to the molding press or extruder for a given recipe blend of material to be molded or extruded, the natural granular plastic resin material is often stored in one or more depots which may be several hundred feet from the molding press or extruder.

Typically, when a prior art system is actuated, the system conveys material to only one receptacle at any one time. The receptacles are loaded sequentially, one at a time with no temporal overlap.

Each prior art receptacle has a level sensor and vacuum valve. The vacuum valve connects the receptacle to the vacuum line and hence to the vacuum pump. The level sensor and the vacuum valve for each receptacle connect, together with level sensors and vacuum valves for the other receptacles, to a central controller. The controller detects low material level at each receptacle as signaled by the associated sensor and actuates the on/off vacuum valve at that receptacle to load the receptacle. The controller sequences through the receptacles to check individual receptacle material levels and loads the individual receptacles as required. FIG. 3a and FIG. 4a are representative of these aspects of the prior art.

In known prior art material feeding and handling systems, if the natural granular plastic resin material is common to all of the process machines, namely common to all of the molding presses or extruders such as where all of the molding presses or extruders are processing polyethylene for example, it becomes cost effective to run only a single material line and to T-connect off this line to the individual receptacle for natural granular resin material to be furnished to each molding press or extruder. Such systems may be dedicated to distribution of natural granular plastic resin material only, since natural granular plastic resin material constitutes the largest part of the material handling requirement. Color material and re-grind granular plastic resin material may be handled separately by smaller local systems, with one such “local” system for color material and another for re-grind material being associated with each molding press or extruder.

The following table presents a typical cost break-down for a prior art material handling system of this type, such as would be dedicated to distribution of only natural granular resin material in a twenty (20) process machine molding or extrusion facility, with a level sensor and on/off vacuum valve at each one of the twenty receptacles for natural granular resin.

TABLE 1

| COMPONENT | COST |
|---|---|
| Vacuum Pump | $4,000.00 |
| Pump Filter Station | $2,000.00 |
| Central Control Station | $2,000.00 |
| Wiring to Twenty Granular Resin | $2,000.00 |
| Receptacles | |
| Common Vacuum Lines Installed | $5,000.00 |
| Throughout Ceiling to Service Twenty | |
| Granular Resin Receptacles | |
| Twenty Receiving Device (one at each of | $20,000.00 |
| the twenty molding presses or extruders | |
| @ $1,000.00) | |
| TOTAL COST | $40,000.00 |

### SUMMARY OF THE INVENTION

In one of its aspects, this invention provides methods and apparatus for supplying plastics-related granular resin material preferably to a plurality of receptacles for subsequent processing, such as by molding or extrusion. The method preferably includes applying vacuum to granules of material in a supply depot to draw substantially a granule stream from the supply depot and into a conduit, continuing to apply vacuum to substantially draw the stream past sequentially positioned individual receptacles, and substantially stripping granules from the stream for supply of the receptacles preferably by passing the stream along a protuberance.

In yet another one of its aspects, this invention provides a method for filling a plurality of receptacles with granular material from a remote storage location without electrical connection between the receptacles and the remote storage location, with the receptacles lacking both material level and material weight sensors and preferably being both electrically and optically inactive. The method includes substantially pneumatically conveying a stream of the granular resin material from the remote storage location through a conduit communicating with the receptacles preferably at discreet locations and diverting granules from the stream substantially concurrently into the receptacles preferably until all of the communicating receptacles are substantially filled.

In still another one of its aspects, this invention provides a method for supplying granular material to a plurality of receptacles where the method includes substantially pneumatically circulating a stream of granular material around a loop which is in pneumatic communication with the receptacles and diverting granular material from the stream preferably for passage into at least two of the receptacles substantially concurrently. In this aspect of the invention, diverting the granules from the stream for passage into at least two of the receptacles concurrently is preferably performed mechanically.

In this aspect of the invention, the loop is preferably a closed loop.

In this one of its aspects, the invention preferably further includes pneumatically circulating a stream of granular material substantially around a loop in pneumatic communication with the receptacles and substantially diverting granules from the stream for passage into at least two of the receptacles concurrently preferably until granular material from the stream has substantially reached a predetermined level at a preselected location communicating with the loop.

In yet another of its aspects, this invention embraces a method for supplying granular material to a plurality of receptacles for subsequent processing such as by molding or extrusion where the method includes applying vacuum to granules and material in a supply depot substantially to draw a granular stream therefrom, substantially vacuum drawing the stream past sequentially positioned individual ones of the receptacles and substantially stripping granules from the stream for supply of the receptacles preferably by passing the stream along a protuberance. In this aspect of the invention stripping is preferably at least in part performed by diverting granules from the stream into one or more of the receptacles by passing the stream along a collection of transverse protuberances positioned proximate to downwardly directed granule passageways leading to the receptacles. Stripping is most preferably performed by substantially mechanically diverting the granules.

In this aspect the invention may further embrace drawing the stream concurrently past the receptacles of the plurality and may yet further embrace opening all of the receptacles substantially concurrently thereby permitting substantially downward flow of granular material into collection means for subsequent processing.

Desirably, the diverting is performed by passing the stream along the transverse protuberances concurrently.

The method may further include the step of halting application of vacuum when granular material conveyed by the granular stream has substantially reached a predetermined level of a selected measuring station. Preferably the granular material reaching the predetermined level at a selected measuring station has been stripped from the stream.

Further desirably, all discharge conduits positioned in association with the receptacles are preferably substantially concurrently filled until reaching capacity regardless of capacity or material level requirement at a given discharge conduit. There may be one protuberance for each receptacle or a plurality of protuberances for at least one receptacle. The method may preferably further embrace collecting from the stream granules remaining therein after the stripping operation has been completed and may preferably further embrace collecting those granules after the stream has passed the last of the receptacles.

The method may preferably further embrace re-introducing the collected remaining granules into the stream drawn from the supply depot. Most preferably the collected remaining granules are re-introduced or recycled into the stream at a position substantially upstream of a first one of the protuberances.

Most preferably, the steps of applying vacuum to granules of material in a supply depot substantially to draw a granule stream therefrom, vacuum drawing the stream past sequentially positioned individual ones of the receptacles and stripping granules from the stream for supply of the receptacles substantially by passing the stream along a protuberance are preferably performed repeatedly, at preselected time intervals.

Re-introducing the granules into the stream for recycling is preferably effectuated by halting application of vacuum to a valve flap substantially separating the collected, excess material to be recycled from a conduit through which the stream passes thereby permitting the valve flap to open substantially responsively to weight of the granular material bearing thereon preferably for downstream passage and joining with a stream drawn from the depot.

In yet another of its aspects, this invention provides substantially wireless apparatus for supplying granular plastic resin material to a plurality of storage receptacles for subsequent processing such as molding or extrusion where the apparatus preferably includes a depot for holding the granular plastic resin material to be supplied, a vacuum pump, a conduit connecting the depot with the pump for vacuum powered flow of granular plastic resin material through the conduit from the depot, with the conduit including at least one aperture therein for delivery of the granular material therethrough from the conduit to at least one of the storage receptacles. In this aspect of the invention, the apparatus further and preferably includes means for strippingly deflecting granular material flowing within the conduit into the aperture, a connector connected to the conduit upstream of the pump for collecting granular resin material which has passed by the aperture, which collector additionally communicates with the conduit proximate the depot, upstream of the aperture, for recycling the collected granular material into the conduit for flow therethrough together with granular material drawn from the depot.

The apparatus preferably further includes means for detecting granular plastic resin material level in the collector and deenergizing the pump upon the granular material being of predetermined level. The apparatus preferably still further includes a timer for periodically actuating the pump and thereby drawing granular resin material through the conduit to supply the storage receptacles.

In yet another of its aspects, this invention provides wireless vacuum powered apparatus for supply of a plurality of plastic resin material processing machines with granular plastic resin material where the apparatus preferably includes a depot for holding a supply of the plastic resin material, a collector for substantially collecting and substantially recycling plastic resin material conveyed from the depot and bypassing the processing machines, a conduit loop leading from the depot and returning to the collector, where the collector communicates with the depot to close the loop, with the loop having a central portion passing in proximity to the processing machines and the apparatus preferably further includes a plurality of connectors in the conduit for substantially directionally diverting granular resin material for transport to the processing machines as the granular resin material flows through the conduit. In this aspect of the invention, the connectors are preferably T-type and preferably extend into the conveyor conduit to substantially downwardly divert granular plastic resin material flowing through the conduit to respective ones of the processing machines.

In yet another of its aspects, this invention provides an endless loop conduit for vacuum conveyance of granular plastic resin material to plastic material processing machines where the apparatus preferably includes a depot for housing a supply of plastic resin material, a collector defining a pair of fluidically connected chambers for respectively receiving and discharging into the conduit loop granular plastic resin material conveyed via the conduit loop from the depot which has bypassed the processing machines, and means in the conduit loop for substantially divertingly transporting granular plastic resin material flowing through the conduit loop. In this aspect of the invention the apparatus preferably further includes a valve between the fluidically connected chambers for substantially controlling flow of granular resin material from the receiving chamber into the discharge chamber responsively to vacuum drawn in the loop.

In this aspect of the invention conveyance is preferably under vacuum and the loop preferably further includes means for drawing vacuum in the loop at the discharge chamber thereby to draw granular plastic resin material from the receiving chamber and along the loop for delivery of at least a portion of the granular plastic resin material to the processing machines with residual granular plastic resin material entering the receiving chamber and being stored therein for subsequent delivery to the discharge chamber for recycling through the loop.

In still another one of its aspects, this invention provides apparatus for supplying a plurality of plastic resin material processing machines with granular plastic resin material where the apparatus preferably includes a first chamber for housing a supply of the granular plastic resin material, a second chamber for receiving and discharging into the first chamber granular plastic resin material which has been conveyed from the supply depot and has bypassed the processing machines, a loop conduit connecting the first and second chambers and intermediately thereof passing in proximity to the processing machines and preferably a plurality of T-type connectors in the conveyor conduit for substantially diverting and substantially downwardly transporting granular plastic resin material flowing through the conveyor conduit to respective ones of the processing machines.

In this aspect of the invention the loop conduit preferably further includes pump means for drawing vacuum in the loop adjacent to the second chamber thereby to draw granular resin material from the first chamber and along the loop for delivery of at least a portion of the material to the processing machines, with residual granular plastic resin material entering the second chamber for storage therein and subsequent delivery to the first chamber for recycling through the loop.

In this aspect of the invention, the first and second chambers are in fluidic communication with one another. A gate or pneumatically actuated valve separates the chambers and closes to preclude gravity induced material flow downwards from the first chamber to the second chamber responsively to vacuum drawn in the upper one of the two chambers. The upper chamber preferably connects to the loop conduit more proximately to the pump than does the lower chamber with a valve between the chambers opening substantially responsively to pressure of granular resin material in the upper chamber whenever the pump is not operating.

In this aspect of the invention the apparatus preferably includes means for sensing when a predetermined amount of granular material has occupied the upper chamber, by passage through the loop conduit, and halting the vacuum in response thereto.

In a further manifestation of this aspect of the invention, the lower chamber preferably empties downwardly into an end of the loop conduit which is proximate juncture of the loop conduit and the material supply depot, to recycle granular plastic resin material from the lower chamber past the T-connectors for supply to the processing machines prior to uncirculated material being drawn from the supply depot.

The invention embraces a valve having a body, an intake conduit connected to the body for flow therein of material, and a closure plate movable between intake conduit open and closed positions and movable transversely with respect to but axially spaced from a discharge end of the intake conduit. A pneumatic piston-cylinder combination is connected to the body for moving the closure plate between open and closed positions. A cam connects to the body for urging the closure plate towards the discharge end while the plate moves from the open to the closed position.

The portion of the plate adapted to occlude the discharge end is preferably planar. Further, the valve may include cam-runners that extend parallel to the direction of plate motion and also extend transversely to the portion of the plate adapted to occlude the discharge end. The cam preferably contacts the cam-runners and urges the closure plate against the discharge end with increasing force as the closure plate moves across the discharge end.

The valve preferably also includes a granular remover positioned so that the closure plate slideably travels along the granule remover, making interfering contact with remaining granules of material adhering to the plate. A deformable scraper may be included as part of the valve. The deformable scraper is preferably adjacent to the inner or outer surface of the intake conduit and has a bottom surface adapted to be upwardly deformed by the closure plate, facilitating a vacuum seal. The bottom surface may be canted with respect to the planar portion of the closure plate.

The valve may also include a guard positioned within the body and proximate the intake conduit. A portion of the closure plate overlying the guard may be planar.

In another of its aspects, the invention provides a method for effectuating a substantially air-tight seal and stopping flow of granular material out a discharge end of an intake conduit. The method includes moving a closure plate from an open position to a closed position by moving the plate transversely with respect to and axially spaced from the discharge. A removal device is positioned for sliding travel of a leading edge of the closure plate along the removal device to interferingly contact and thereby remove granules of material adhering to the plate. The method preferably also includes using a cam to urge the closure plate towards the discharge end as the closure plate moves from the open position towards the closed position.

### BRIEF DESCRIPTION OF THE DRAWINGS

FIG. 1 is a schematic isometric depiction of apparatus and a method practiced thereby for supplying granular material to a plurality of receptacles in accordance with the invention.

FIG. 2a is a sectional side elevation view showing a connector manifesting aspects of the invention.

FIG. 2b is a front view of the connector illustrated in FIG. 2a.

FIG. 3a is a sectional view taken at lines and arrows 3a-3a in FIG. 2.

FIG. 3b is a front view, locking from right to left in FIG. 2a of a deflector portion of the connector illustrated in FIGS. 2a and 2b.

FIG. 3c is a side view of the deflector illustrated in FIG. 3b.

FIG. 4a is a schematic side elevation of a portion of apparatus for supplying granular material to a plurality of hoppers in accordance with aspects of the invention.

FIG. 4b is a schematic side elevation of a portion of apparatus for supplying granular material to a plurality of loaders and hoppers in accordance with the prior art.

FIG. 5a is a front perspective view of discharge conduit and associated hopper mounted on a schematically depicted process machine in accordance with aspects of the invention.

FIG. 5b is a front perspective view of a prior art loader and hopper mounted on a schematically depicted process machine.

FIG. 6a is a front view of a collector in accordance with aspects of the invention.

FIG. 6b is a sectional view taken at lines and arrows 6b-6b in FIG. 6a drawing showing aspects of the collector illustrated in FIG. 6a.

FIG. 7a is an enlarged front view of the collector gate structure shown within circle “A” in FIG. 6a, depicted in the closed position.

FIG. 7b is an enlarged front view similar to FIG. 7a but depicting the collector gate in an open position.

FIG. 8a is partially-sectioned side elevation of a first embodiment of a granular material flow control valve, manifesting aspects of the invention, with the valve depicted in an open position.

FIG. 8b is a partially-sectioned side elevation similar to FIG. 8a but with the valve depicted in a closed position.

FIG. 8c is a partially broken top view of the valve illustrated in FIGS. 8a and 8b, with the valve depicted in the open position shown in FIG. 8a.

FIG. 8d is a bottom view of the valve illustrated in FIGS. 8a and 8c, with the valve depicted in the same open position.

FIG. 8e is a bottom view of the valve illustrated in FIG. 8b, with the valve depicted in the same closed position.

FIG. 9a is a partially-sectioned side elevation of a second embodiment of a granular material flow control valve, manifesting aspects of the invention, with the valve depicted in an open position.

FIG. 9b is a partially-sectioned side elevation similar to FIG. 9a but with the valve depicted in a closed position.

FIG. 9c is a partially broken top view of the valve illustrated in FIGS. 9a and 9b, with the valve depicted in the open position illustrated in FIG. 9a.

FIG. 9d is a bottom view of the valve illustrated in FIGS. 9a and 9c, with the valve depicted in the same open position.

FIG. 9e is a bottom view of the valve illustrated in FIG. 9b, with the valve depicted in the same closed position.

FIG. 10a is a partially-sectioned side elevation of a third embodiment of a granular material flow control valve, manifesting aspects of the invention, with the valve depicted in an open position.

FIG. 10b is a partially-sectioned side elevation similar to FIG. 10a but with the valve depicted in a closed position.

FIG. 10c is a partially broken top view of the valve illustrated in FIGS. 10a and 10b, with the valve depicted in the open position shown in FIG. 10a.

FIG. 10d is a bottom view of the valve illustrated in FIGS. 10a and 10c, with the valve depicted in the same open position.

FIG. 10e is a bottom view of the valve illustrated in FIG. 10b with valve depicted in the same closed position.

### DETAILED WRITTEN DESCRIPTION OF THE INVENTION IN ITS PREFERRED EMBODIMENTS AND THE BEST MODE KNOWN FOR PRACTICE OF THE INVENTION

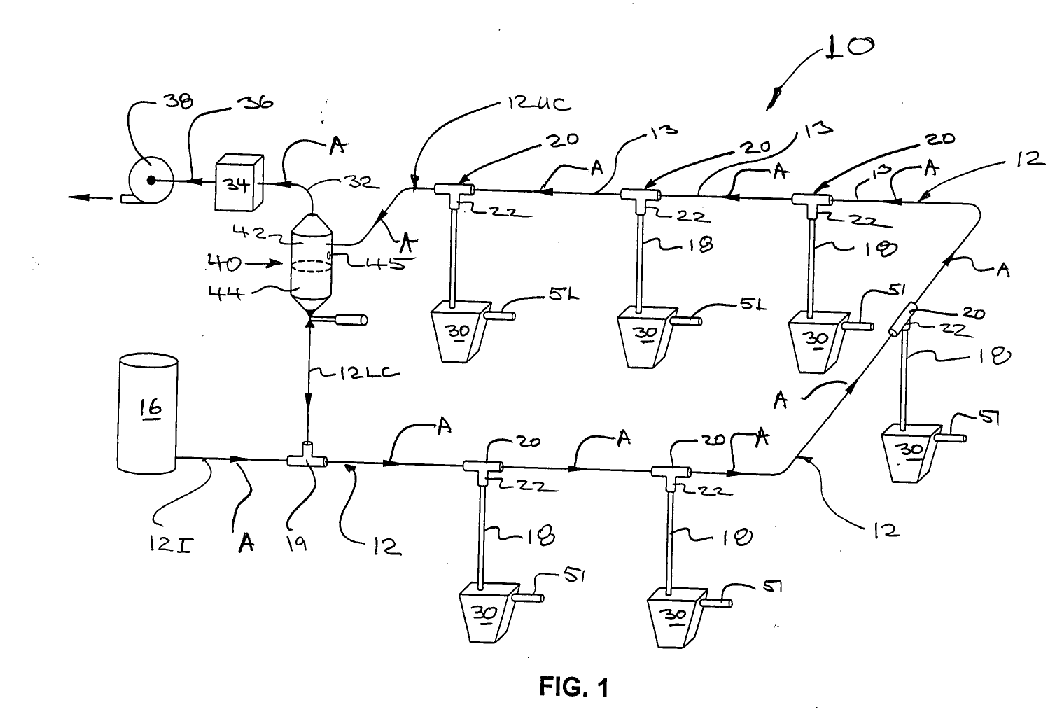

FIG. 1 illustrates substantially wireless apparatus, designated generally 10, for supplying granular material to a plurality of receptacles for subsequent processing, all in accordance with aspects of the invention. Apparatus 10 includes a conduit designated generally 12, which is preferably tubular in form. Conduit 12 is preferably provided in sections, with a plurality of connectors, individual ones of which are designated 20, connecting together sections of conduit 12. Apparatus 10 also preferably includes a vacuum pump 38, a collector designated generally 40 and a series of granular material flow control valves each designated generally 50, which are not visible in FIG. 1 but which are preferably actuated by preferably pneumatically powered piston cylinder combinations designated generally 51 I FIG. 1.

Conduit 12 is preferably in the form of a loop as shown in FIG. 1 and is generally referred to as a “loop conduit”. Loop conduit 12 preferably defines a continuous, preferably closed loop including connectors 20 and preferably including collector 40 for recycling granular plastic resin material traveling through loop conduit 12.

Apparatus 10 may be used to transport granular plastic resin material or other dry granular material.

Each connector 20 is preferably a T-connector. Connectors 20 connect conduit 12 with receptacles, preferably hoppers, receiving granular material; individual hoppers are designated generally 30. A material storage depot designated generally 16 houses a supply of granular plastic resin material and connects to loop conduit 12 for supply of granular material to hoppers 30. Material storage depot 16 is preferably a silo in form.

Each hopper 30 receives and temporarily stores granular material, ultimately to be used by a process machine, such as a plastics invention or compression molding press or an extruder, for example. In some alternate arrangements, granular material temporarily stored in hopper 30 may be furnished from a hopper to a dryer and/or to a gravimetric blender before ultimately going to a molding press, extruder, or other process machine. Similarly, in other alternate arrangements the granular material may be initially introduced into apparatus 10 from a dryer or a gravimetric or other type of blender, in which case the dryer or gravimetric blender may serve as depot 16, or the dryer or gravimetric blender could be positioned between depot 16 and the entry way to loop conduit 12.

Each connector 20 preferably provides a connection between loop conduit 12 and an associated discharge conduit 18. Each discharge conduit 18 preferably leads downwardly and receives granular material from loop conduit 12 via a connector 20. Each discharge conduit 18 preferably communicates with a material hopper to deliver granular material thereinto from loop conduit 12. Preferably individual granular material flow control valves 50 are preferably positioned at the outlet of each individual discharge conduit 18 emptying into hopper. Granular material flow control valves 50 in the closed position facilitate maintenance of a near vacuum condition within loop conduit 12 and discharge conduits 18.

Collector 40 gathers and recycles any granular resin material traveling through loop conduit 12 that did not enter any one of downwardly directed discharge conduits 18 during the previous pass of granular resin material through loop conduit 12. A filter conduit 32 leads from collector 40 to a filter 34. A pump conduit 36 leads from filter 34 to vacuum pump 38.

Upon actuation of vacuum pump 38, vacuum is drawn in pump conduit 36, filter 34, filter conduit 32 and in at least an upper chamber 42 of collector 40. Upper chamber 42 is the portion of collector 40 into which loop conduit 12 delivers any residual granular material remaining after traveling the length of loop conduit 12 from material storage depot 16. Actuation of vacuum pump 38 results in vacuum being drawn through the portion of loop conduit 12 labeled 12UC, with vacuum propagating back through loop conduit 12, in the direction opposite the arrows illustrated in FIG. 1, to a T-joint 19, from which vacuum further propagates back to material storage depot 16 via the portion of loop conduit 12 adjacent depot 16; this portion of loop conduit 12 is designed 12I, where “I” denotes “initial.” The designation 12UC identifies the portion of loop conduit 12 which communicates with upper chamber 42 of collector 40, where “UC” denotes “upper chamber.”

Vacuum also preferably propagates from joint 19 upwardly through the portion of loop conduit 12 designated 12LC to a lower chamber 44 of collector 40. While this vacuum is being drawn, granular material flow control valves 50 are closed. Granular material flow control valves 50 are opened and closed by associated individual pneumatic piston-cylinder combinations 51. When valves 50 close, they seal loop conduit 12 from ambient and permit the required vacuum to be drawn within loop conduit 12 to convey granular material therewithin.

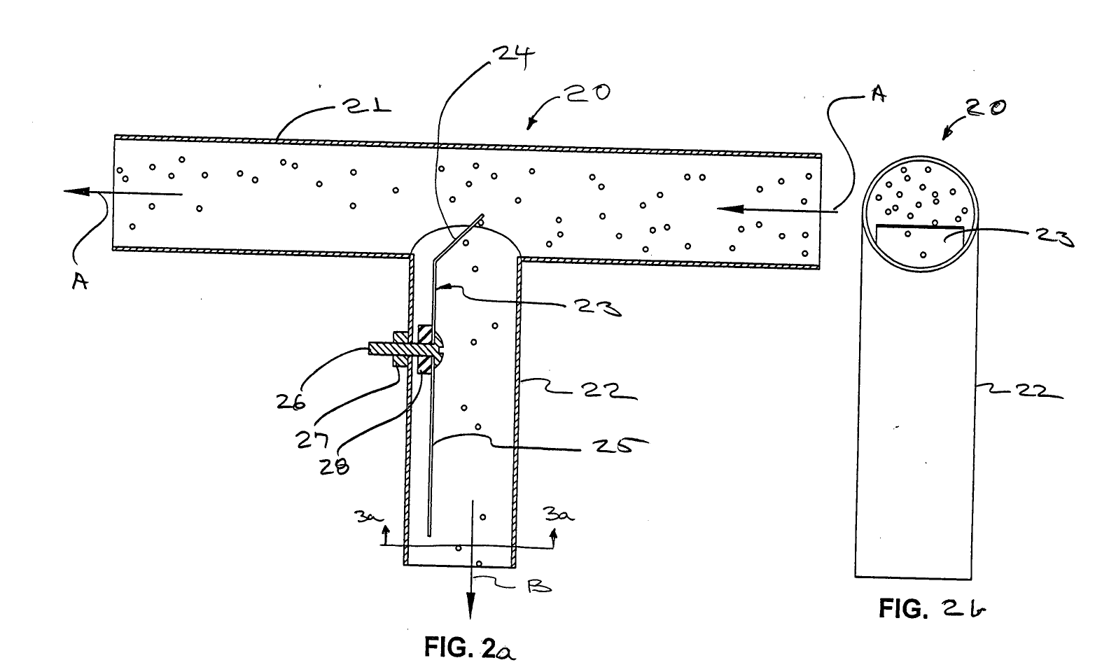

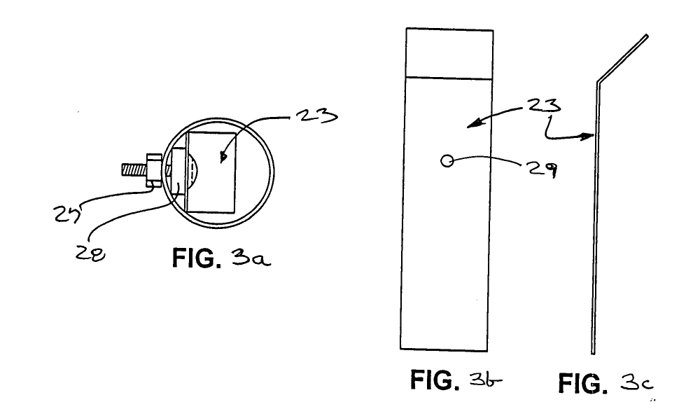

Vacuum within loop conduit 12 draws granular material out of material storage depot 16 and through loop conduit 12 in the direction of arrows A in FIG. 1. As granular resin material is drawn from depot 16, the granular resin material travels through loop conduit 12 under influence of the drawing vacuum. Referring to FIG. 2, during travel, some granules are “stripped” from the flowing stream of granular material by encounter with individual deflectors 23 within respective connectors 20. The stripped granules fall downwardly through the vertically elongated portion 22 of connector 20 into a downwardly directed discharge conduit 18 where the granules begin to accumulate, piling up on an associated closed granular material flow control valve 50.

Referring again to FIG. 1, as remaining portions of granular resin material continue to flow through loop conduit 12 in the direction of arrows A and pass through connectors 20, a residual amount of granular resin material eventually reaches collector 40 due to vacuum drawn in loop conduit 12. This residual granular resin material comes to rest in an upper chamber 42 of collector 40, as vacuum pump 38 continues to draw vacuum in upper chamber 42 via pump conduit 36, filter conduit 32 and through filter 34.

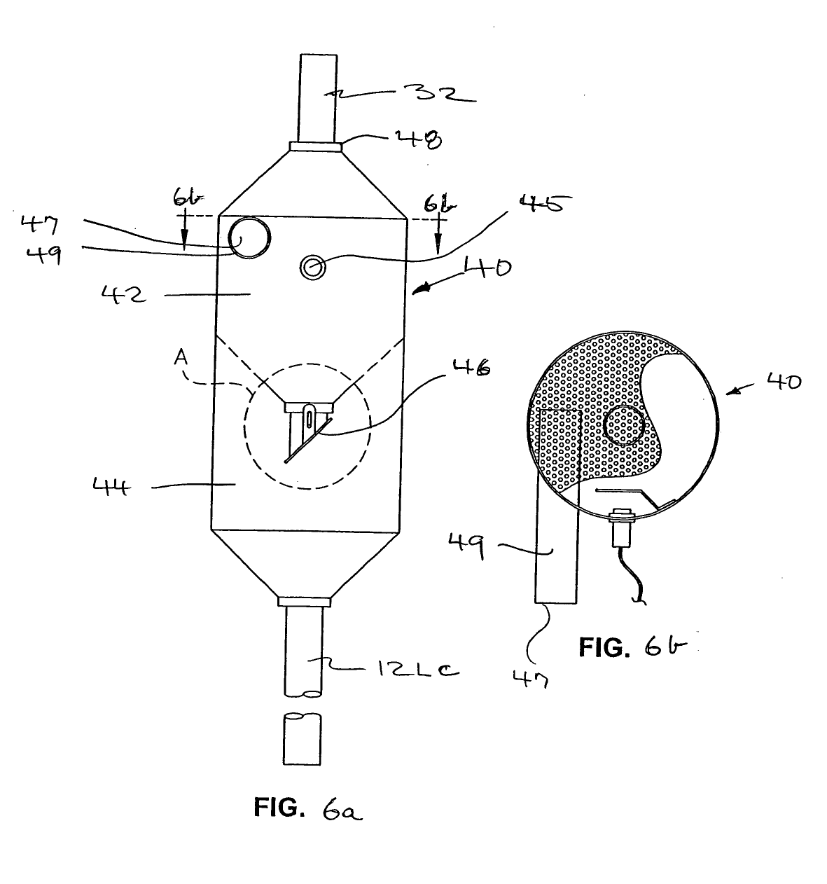

A material level sensor 45, which is best shown in FIGS. 6a and 6b, positioned within and connected to collector 40, senses the level of granular resin material in upper chamber 42 of collector 40. When the granular resin material reaches a predetermined level sensed by level sensor 45, vacuum pump 38 turns off thereby stopping draw of vacuum and resulting conveyance of granular resin material through loop conduit 12. When vacuum draw stops, hinged a collector gate 46 separating upper chamber 42 from lower chamber 44 within collector 40 opens downwardly, since there is no vacuum being drawn to retain collector gate 46 in a closed, upper position, against the force of gravity. Residual granular resin material in upper chamber 42 falls into lower chamber 44 and is subsequently recycled back through loop conduit 12 upon closure of collector gate 46 by the reapplication of vacuum.

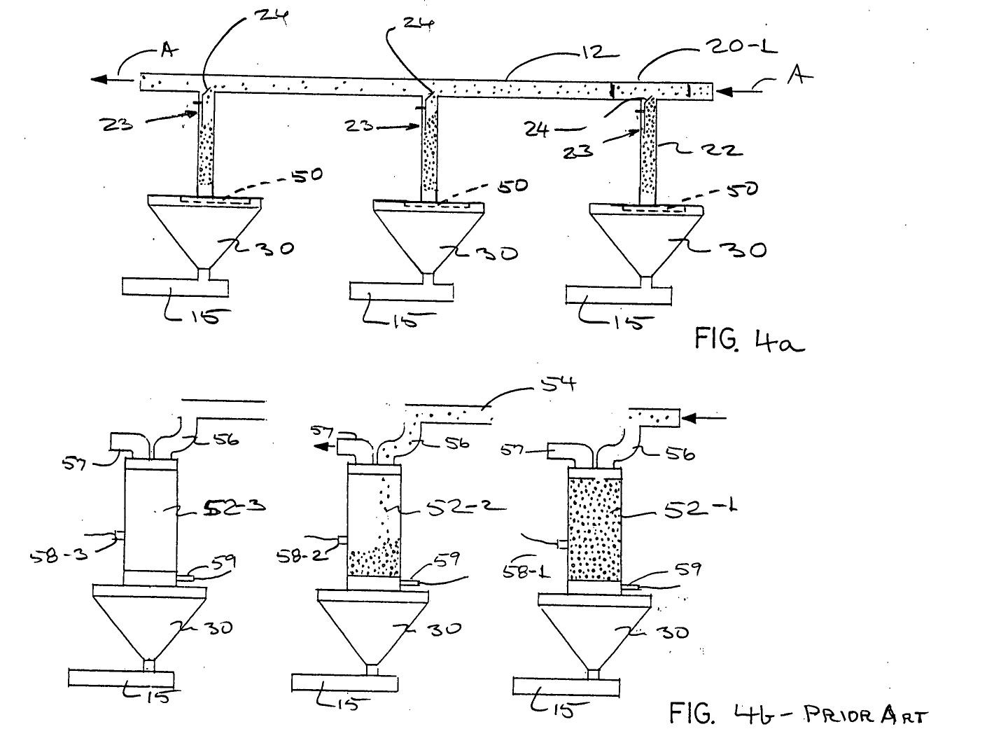

Referring to FIGS. 2a through 3c, the preferred embodiment of connector 20 includes a horizontally elongated conduit portion 21 and an adjoining vertically elongated conduit portion 22. Connector 20 preferably fits into a portion of loop conduit 12 so that the granular resin material flowing within loop conduit 12 smoothly flows into and along horizontally elongated conduit portion 21. With the interiors of conduit portions 21 and 22 being in fluid communication, some of the granular material flowing through a connector 20 in the direction of arrows A in FIGS. 1 and 2a will fall into vertically elongated conduit portion 22 of connector 20 and fall downwardly, in the direction of arrow B in FIG. 2a .

As depicted in FIG. 2a, horizontally and vertically elongated conduit portions 21 and 22 are preferably about the same inner diameter; horizontally elongated conduit 22 is desirably the same inner diameter as the conduit segments 13 which run between respective connectors 20 to define loop conduit 12. Extremities of loop conduit segments 13 and horizontally elongated conduit portions 21 preferably are positioned to be proximate one another, to be nearly if not actually abutting and are held together preferably by plastic sleeves which may be somewhat flexible or may be molded as essentially rigid pieces. Cement or other adhesive may be used if necessary. In either case the sleeves, which are not shown in the drawings, are preferably fabricated with the portions which respectively receive the respective ends of conduit segment 13 and horizontally elongated conduit portion 21 having slightly small inner diameters than the outer diameters of the respective ends of conduit segment 13 and horizontally elongated conduit portion 21, to provide a slight interference fit. With this arrangement, the conduit segments 13 and connectors 20 may be easily assembled, disassembled and reassembled manually, usually without any tools being required. This arrangement is highly advantageous in the event of occurrence of a clog of the granular resin material since loop conduit 12 may be quickly disassembled, the clog removed, and loop conduit 12 reassembled for resumption of operation with minimum down time.

Positioned within vertically elongated conduit portion 22 and extending upwardly at least somewhat into horizontally elongated conduit portion 21 is a deflector plate designated generally 23, which includes an angular portion 24 and a vertical portion 25. Some granular resin material traveling in the direction of arrows A in FIG. 2a encounters angular portion 24 of deflector plate 23 and falls downwardly into vertically elongated conduit portion 22 of connector 20 in the direction of arrow B in FIG. 2a.

The position of deflector plate 23 and hence the amount by which deflector plate 23 extends into conduit 12 is preferably adjustable. Deflector plate 23 preferably is retained in position by a machine screw 26-nut 27-bushing-28 combination. Machine screw 26 passes through deflector plate 23, specifically through a deflector plate hole 29 therein, through bushing 28, through a hole in vertical conduit portion 22, and is retained by nut 27, which bears against the exterior of vertical conduit portion 22, as illustrated in FIGS. 2a and 3a.

The hole in vertical conduit portion 22 may be configured as a vertically elongated slot. Thus, if it is desired for deflector plate 23 to protrude further into horizontal conduit portion 21, an operator merely loosens nut 27 and slides the assembly of deflector plate 23, bushing 28 and machine screw 26 vertically upwardly, in the vertically elongated slot, until deflector plate 23 has assumed the desired position. The operator then tightens nut 27.

As an alternative arrangement, the hole 29 in deflector plate 23 may be configured as a vertically elongated slot while the hole in vertical conduit portion 22 may be circular. In such case vertical adjustment of deflector plate 23 may be accomplished by loosening nut 27 and manually moving deflector plate 23 vertically, either up or down, until deflector plate 23 has attained a desired position whereupon nut 27 may be retightened to hold deflector plate 23 in the new, desired position. With this arrangement, it is necessary that vertically elongated conduit portion 22 of connector 20 be easily disassembled from discharge conduit 18 in order that an operator may reach, either manually or with the use of tools, deflector plate 23 within vertically elongated conduit portion 22 of connector 20. This alternate arrangement providing for vertical adjustment of deflector plate 23 may be desirable when the granular material to be conveyed by loop conduit 12 is very fine so that a high degree of vacuum must be maintained within loop conduit 12. With this arrangement eliminating the vertically elongated slot configuration of the hole in vertically elongated conduit portion 22 of connector 20, a higher degree of vacuum may be maintained within loop conduit 12 since there is substantially no air leakage into vertically elongated conduit portion 22 of connector 20 through the hole therein and around screw 26.

A major advantage with the invention is the elimination of electrical wiring running between a central control point and a given granular resin material supply station, as defined by a connector 20, an associated discharge conduit 18, and an associated granular resin material flow control valve 50. No electric signals are required to be sent to or from these components to control loading of hoppers 30.

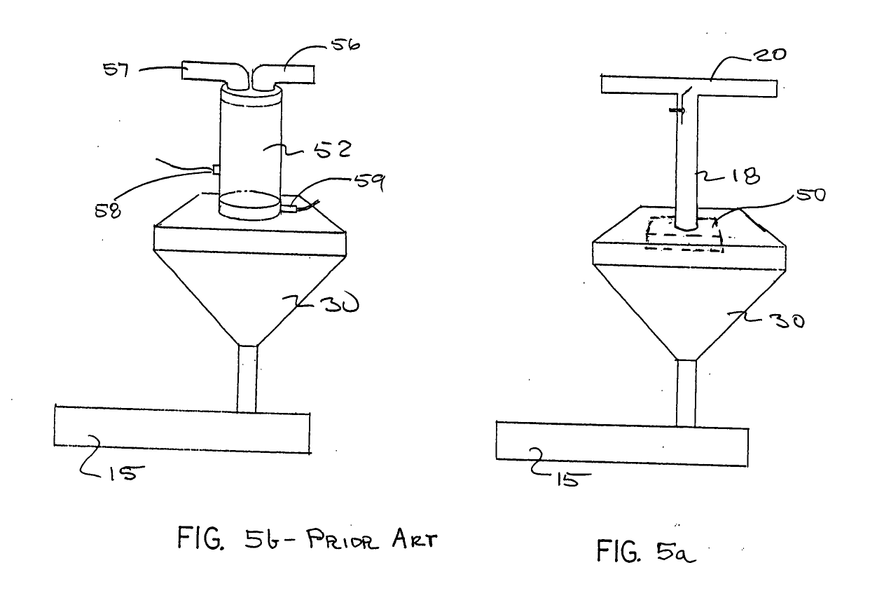

With specific reference to FIGS. 1, 2, 3 and 4a, as vacuum is drawn through loop conduit 12, granular resin material is drawn from depot 16 through loop conduit 12 in the direction of Arrows A in FIG. 4a. The granules encounter angular portion 24 of deflector plate 23 at a first T-connector, designated 20-1 in FIG. 4a. Some granules drop down into vertically elongated conduit portion 22, while the vacuum continues to pull any air within the system and remaining granules in the direction of arrows A.

The process of filling discharge conduit 18 and vertical conduit 22 associated with T-connector 20-1 continues until the discharge conduit 18 and vertical conduit portion 22 associated with T-connector 20-1 are full so that granular material reaches the extremity of vertically elongated conduit portion 22 where it joins horizontally elongated conduit portion 21 of connector 20-1. Even before the discharge conduit 18 and the vertically elongated conduit portion 22 of connector 20-1 are full of granules and the granules begin to back up into horizontally elongated conduit portion 21 of connector 20-1, additional granules of plastic resin material moving in the direction of arrows A pass through connector 20-1 and travel to second T-connector with some of these granules encountering angular portion 24 of deflector plate 23 associated with second T-connector 20-2. Discharge conduit 18 and vertical portion 22 associated with T-connector 20-2 proceed to fill with granules.

Filling of discharge conduits 18 and vertically elongated portions 22 of associated connector 20 is not sequentially, one-by-one but is usually accomplished at least somewhat concurrently. Some granules are not stripped at connector 20-1 even though connector 20-1 may not be full. Rather, some granules continue on to second T-connector 20-2, third T-connector 20-3 and so on. With successive travel of granules past deflector plates 23, a granule may be deflected into the vertically elongated conduit portion 22 of the associated connector 20, disappearing downward into the associated discharge conduit 18, or the granule may continue on through loop conduit 12.

Typically during operation of apparatus in accordance with the invention such as illustrated in FIG. 4a, a substantial number of granules will initially be deflected downwardly at connectors 20-1 and 20-2 with a lesser number of granules being deflected downwardly at connector 20-3 and relatively few granules continuing to travel in loop conduit 12 pass connector 20-3. As the vertically elongated portion of connector 20-1 becomes full of granules, typically the rate of fill of vertically elongated portion 22 of connector 20-2 accelerates as does the rate of fill of vertically elongated portion 22 of connector 20-3. As the vertically elongated portion 22 of connector 20-2 becomes full, the filling of vertically elongated portion 22 of connector 20-3 accelerates and the fill of additional connectors, to the left in FIG. 4a and not shown in the drawing, but which will be designated 20-4, 20-5, 20-6, etc., accelerates.

This process continues until all discharge conduits 18 and vertically elongated conduit portions 22 of connector 20 have filled and thereafter until upper chamber 42 of collector 40 fills to a predetermined level detected by sensor 45.

By contrast, FIG. 4b illustrates a prior art arrangement where a loader 52, such as that illustrated in U.S. Pat. No. 6,089,794, is provided mounted on the top of each hopper 30. Loader 52 connects to a pneumatic material feed conduit 54 via a receptacle inlet conduit 56 and completely fills before the next loader 52 is allowed to fill. For example, in the prior art, loader 52-1 fills until its wired level sensor 58-1 indicates to a central processor that loader 52-1 is full. At that point, the central processor shuts off a valve, drawing a vacuum from line 54 into unit. The process then repeats with regards loader 52-2 and its associated electrically connected level sensor 58-2. The process then repeats again with loader 52-3 and its associated electrically connected level sensor, and so on. The process of the prior art is discrete, requiring information processing, wiring and additional components. Loaders 52 are utilized sequentially with no simultaneous or concurrent operating capability. Loaders 52 may be emptied by opening an electrically actuated discharge valve at the bottom of loader 52; the discharge valve is denoted 59.

FIG. 5a illustrates a portion of apparatus in accordance with the preferred embodiment of the invention, namely T-connector 20, discharge conduit 18, hopper 30, and, in dotted lines and in schematic form only, granular material flow control valve 50 which facilitate wireless material feeding. Contrasting, FIG. 5b illustrates a prior art arrangement where each loader 52 includes a pneumatic material feed conduit 56 for intake of granular resin material, an additional, second vacuum line 57 to each loader 52, an electrically powered level sensor 58 requiring electrical wiring to the loader, a possibly electrically actuated discharge valve 59 and a central control station, not shown in the drawings.

As shown in FIG. 5b, prior art loaders 50 fill with material serially, not simultaneously. Each loader 50, in sequence, fills with granular resin material until an associated level sensor 58 determines the loader 50 is full.

The invention provides substantial cost savings over prior art devices. Table 2 presents representative costs associated with implementation of the apparatus aspects of the invention. These should be compared with the costs associated with prior art apparatus, such as disclosed in FIG. 5b, with such costs being set forth in Table 1, above.

TABLE 2

| COMPONENT | COST |
|---|---|
| Vacuum Pump | $4,000.00 |
| Pump Filter Station | $2,000.00 |
| Common Material Line | $5,000.00 |
| Dispense Valve at Each Machine | $4,000.00 |
| (20 @ $200) | |
| TOTAL COST | $15,000.00 |

As apparatus manifesting the invention operates, at least some, and in many cases all, discharge conduits 18 fill substantially concurrently regardless of the granular resin material level requirement or granular resin material consumption rate of the process machine to which a given discharge conduit 18 furnishes granular resin material. Granular resin material is thus supplied to each molding press or extruder without the need for individual sensors and individual vacuum receivers at each such molding press or extruder being supplied with granular resin material.

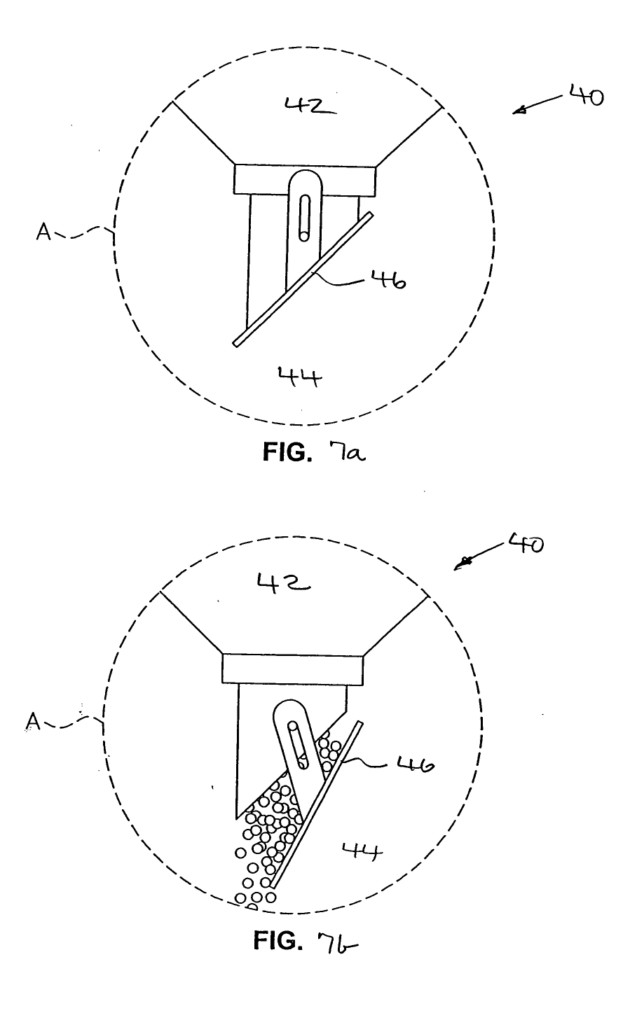

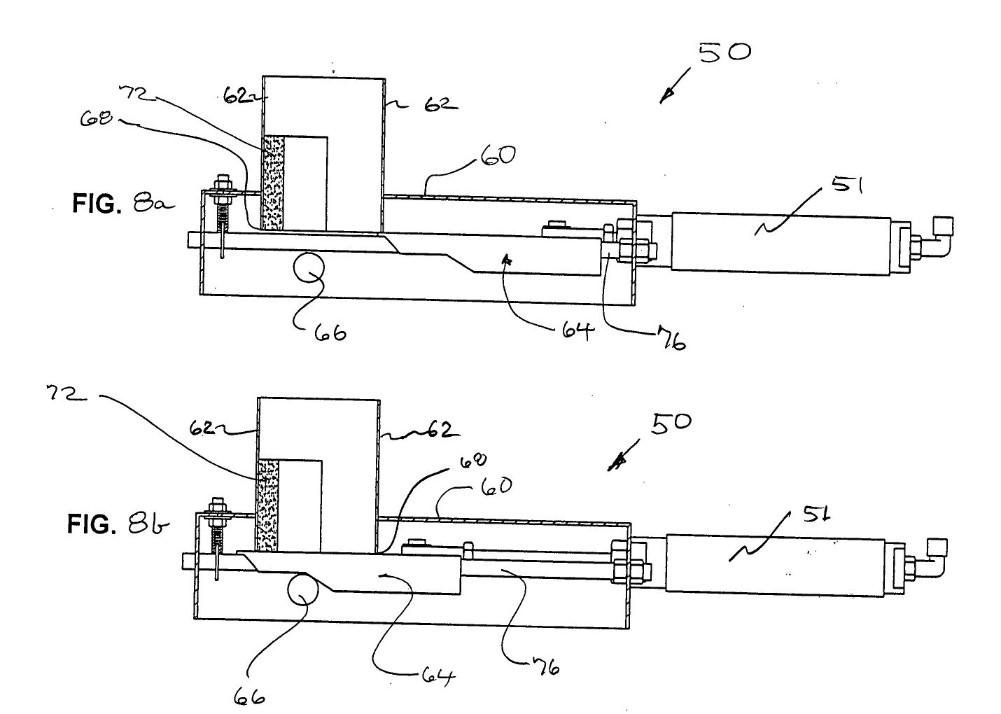

Referring to FIGS. 6a through 7b, a collector 40 serves to recycle residual granular material from an end of loop conduit portion 12UC along loop conduit portion 12LC and back into a beginning portion of loop conduit 12 communicating with material storage depot 16.

As granules are conveyed by vacuum through loop conduit 12, not all granules are stripped away. These residual granules travel through conduit portion 12UC, through collector entrance 47, and into upper chamber 42 of collector 40. While collector entrance 47 may be a bore in upper chamber 42, in the illustrated and preferred embodiment collector entrance 47 is defined by a material entrance tube 49 extending into and partially through upper chamber 42 of collector 40. During the filling process for connector 20 and the various discharge conduits 18, a collector gate 46, which is positioned within collector 40 and separates upper and lower chambers 42, 44, is closed. Upper chamber 42 of collector 40 fills until level sensor 45 indicates that upper chamber 42 has filled to a predetermined level. When sensor 45 indicates the desired predetermined level of material is present in upper chamber 42, discharge conduits 18 and vertical portions 22 of T-connectors 20 are filled essentially to capacity.

When essentially full capacity of T-connectors 20 and discharge conduits 18 has been reached, as indicated by residual granular material having traveled the length of loop conduit 12 and filled upper chamber 42 of collector 40 to the desired predetermined level, level sensor 45 sends a preferably electrical signal to a controller to deactuate vacuum pump 38. When vacuum pump 38 stops, preferably pivotally hinged collector gate 46 separating upper chamber 42 from lower chamber 44 opens, since there is no longer vacuum drawn in upper chamber 42 to retain collector gate 46 closed. As a result, residual granular resident material resident in upper chamber 42 drops into lower chamber 44 and then drains through the portion of loop conduit 12 denoted 12LC, which connects to the main portion of loop conduit 12 via T-joint 19, as illustrated in FIG. 1.

Upon the next actuation of vacuum pump 38, residual granular resin material is recycled, by again traveling along loop conduit 12 in the direction of arrows A in FIG. 1, joining in such travel with granular resin material drawn from material storage depot 16. Hence, residual granular material in loop conduit 12 is again positioned to enter one of discharge conduits 18 and ultimately to reach one of material storage hoppers 30 upon opening of an associated granular material flow control valve 50.

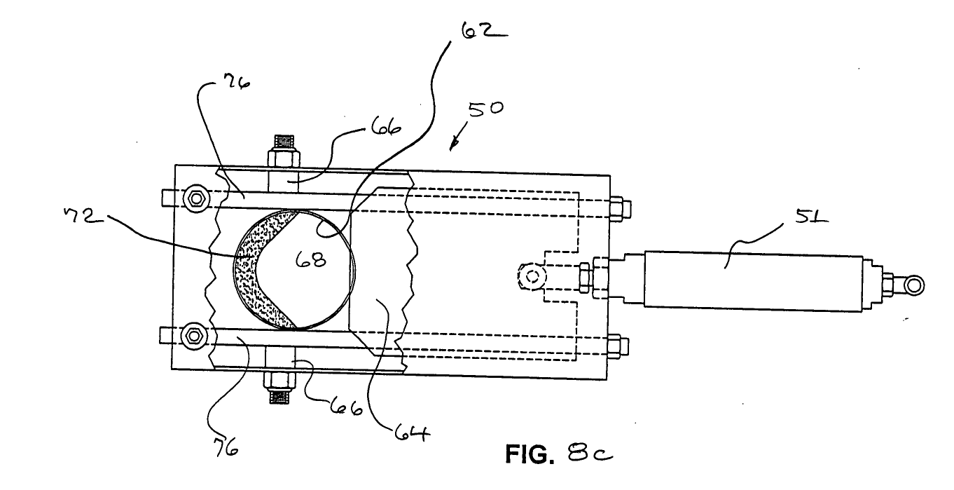

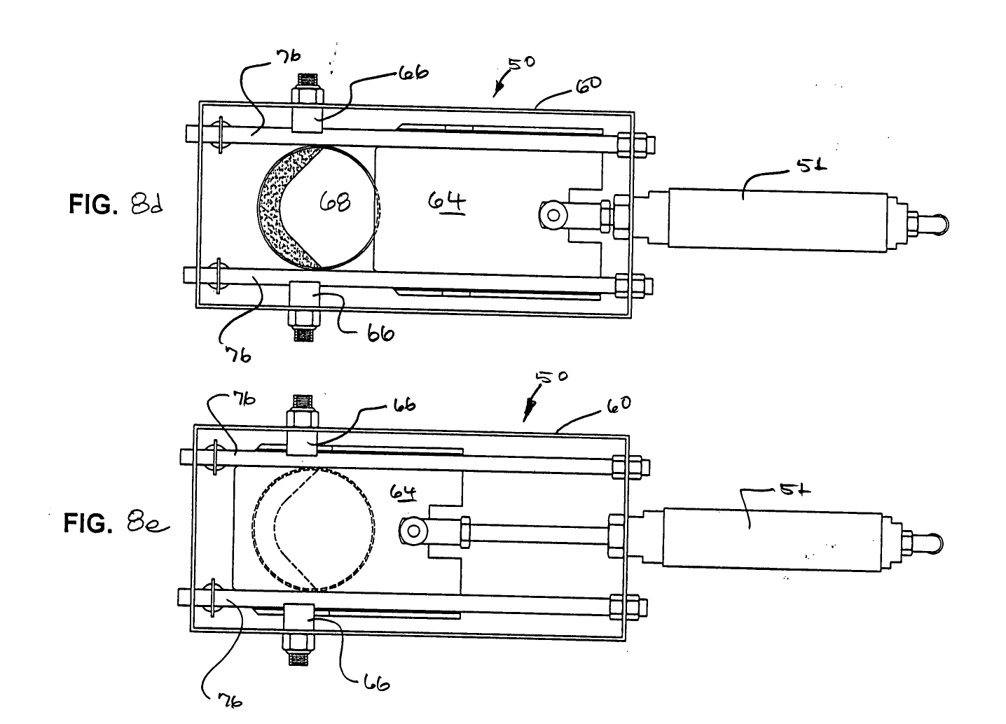

Flow control valve 50 is discussed in further detail below, with various embodiments being shown in FIGS. 8a through 10e.

An exit 48 from collector 40 connects to filter conduit 32, which in turn connects to filter 34. Filter 34 in turn connects to pump conduit 36, which in turn connects to vacuum pump 38. Filter 34 and these associated serial connections facilitate draw of vacuum through upper chamber 42, while substantially preventing granular material from entering and potentially harming vacuum pump 38. Filter 34 preferably catches rogue granules before they reach vacuum pump 38.

Three embodiments of flow valve 50 are illustrated in FIGS. 8a through 8e, FIGS. 9a through 9e, and FIGS. 10a through 10e, respectively.

As granular material is stripped from the moving granular material stream in loop conduit 12, the stripped granular material falls through a vertically elongated conduit portion 22 of a T-connector 20, downwardly into and along discharge conduit 18 and builds-up above an associated closed flow control valve 50. When such associated flow control valve 50 opens, built-up granular material flows through flow control valve 50 downwardly into an associated hopper 30.

When sensor 45 in collector 40 detects collector 40 is filled to a predetermined level, sensor 45 stops vacuum pump 38 and preferably simultaneously opens all flow control valves 50, allowing accumulated granular material to drop through discharge conduits 18 into hoppers 30 which are typically and preferably associated with individual molding presses or extruders.

Flow control valves 50 preferably maintain substantially air-tight vacuum seals at the lower ends of discharge conduits 18 so that air is not drawn upwardly into loop conduit 12 by the vacuum drawn in loop conduit 12 by pump 38. Flow control valves 50 are most preferably actuated by pneumatic piston-cylinder combinations 51, which are preferably driven from a common air supply line, preferably strung along the route of loop conduit 12. With this arrangement, all flow control valves 50 can be actuated simultaneously using a single solenoid control. As a result of this operation, hoppers 30 remain adequately and substantially filled with granular resin material since each hopper is typically recharged every two or three minutes, for example, as the cycle repeats, whether or not an individual hopper is empty.

FIGS. 8a through 8e illustrate a first embodiment of a granular material flow control valve 50 which includes a body 60. Valve 50 includes an intake conduit 62 connected to body 60 for flow of granular material through intake conduit 62 into body 60. Preferably, intake conduit 62 connects to, and may even be defined by the lower end of discharge conduit 18.

Granular material flow control valve 50 includes a closure plate 64 which is movable transversely with respect to and is preferably slightly axially spaced from a discharge orifice 68 of intake conduit 62. Closure plate 64 preferably moves along a continuum of positions, transversely with respect to discharge orifice 68. Pneumatic piston-cylinder combination 51 is preferably connected through body 60 to closure plate 64 in order to reciprocate closure plate 64 preferably between valve open and valve closed positions.

Flow control valve 50 also preferably includes at least one cam rod 66 connected to body 60. As closure plate 64 moves horizontally, from a valve open position to a valve closed position, a downwardly sloping portion of cam runner side 70 of plate 64 contacts cam rod 66, and is urged upwardly by cam rod 66 towards discharge orifice 68. Cam runner sides 70 preferably extend of plate 64 parallel with the direction of plate 64 longitudinal motion and transversely to the planar portion of plate 64 which is adapted to occlude discharge orifice 68.

Granular material flow control valve 50 preferably also includes a granule removal means, such as scraper 72 which is positioned so that a leading edge of closure plate 64 slides closely along scraper 72 therealong. There is preferably nearly, if not fully, interfering contact between scraper 72 and closure plate 64 to remove any granular material riding on or adhering to the upper surface of closure plate 64. Granular material may flow downward into hoppers 30 when associated granular material flow control valves 50 are open but granular material is prevented from passing into hoppers 30 when valves 50 are closed. Note that valves 64 are preferably positioned within hoppers 30, mounted on the closing lids or tops of hoppers 30, as depicted in FIG. 4a.

In the embodiment illustrated in FIGS. 8a through 8e, scraper 72 is located inside intake conduit 62 and extends downwardly just outside of discharge orifice 68. Scraper 72 is desirably rubber and clears granules from closure plate 64 before plate 64 reaches a end of intake conduit 62 to close valve 50. Closure plate 64 reciprocally traverses along longitudinally elongated plate support rods in response to piston-cylinder combination 51.

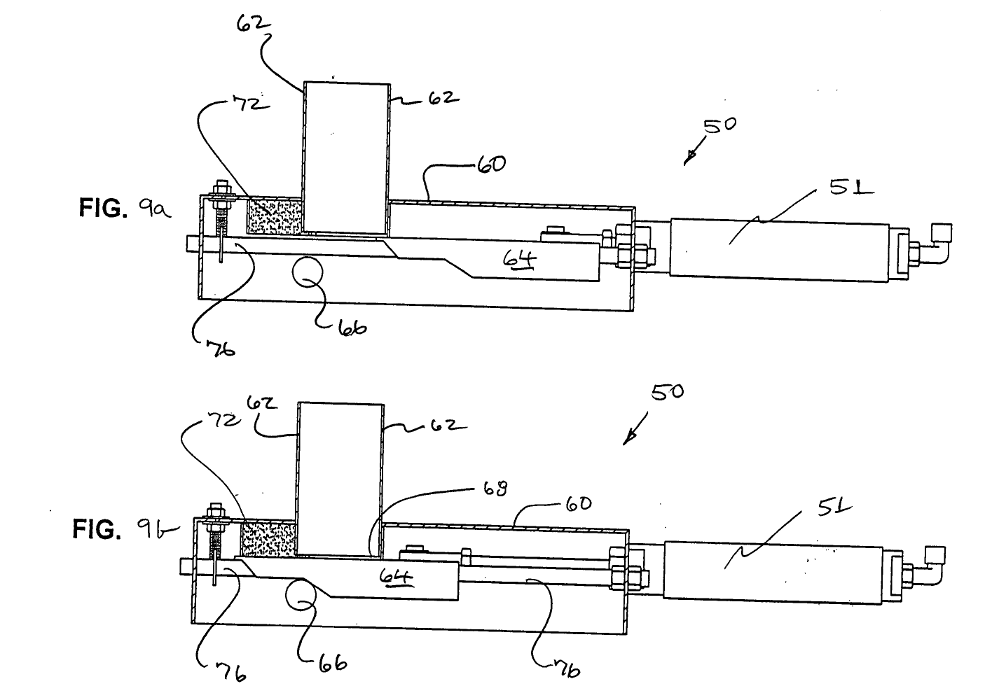

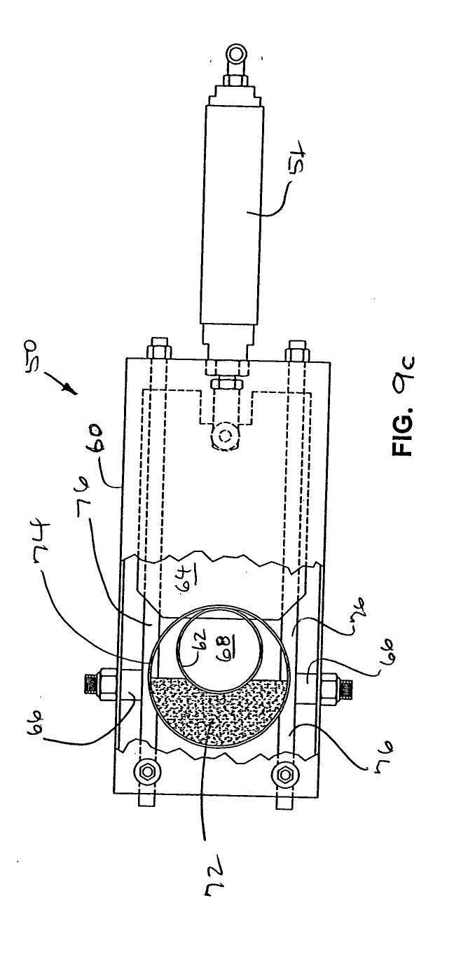

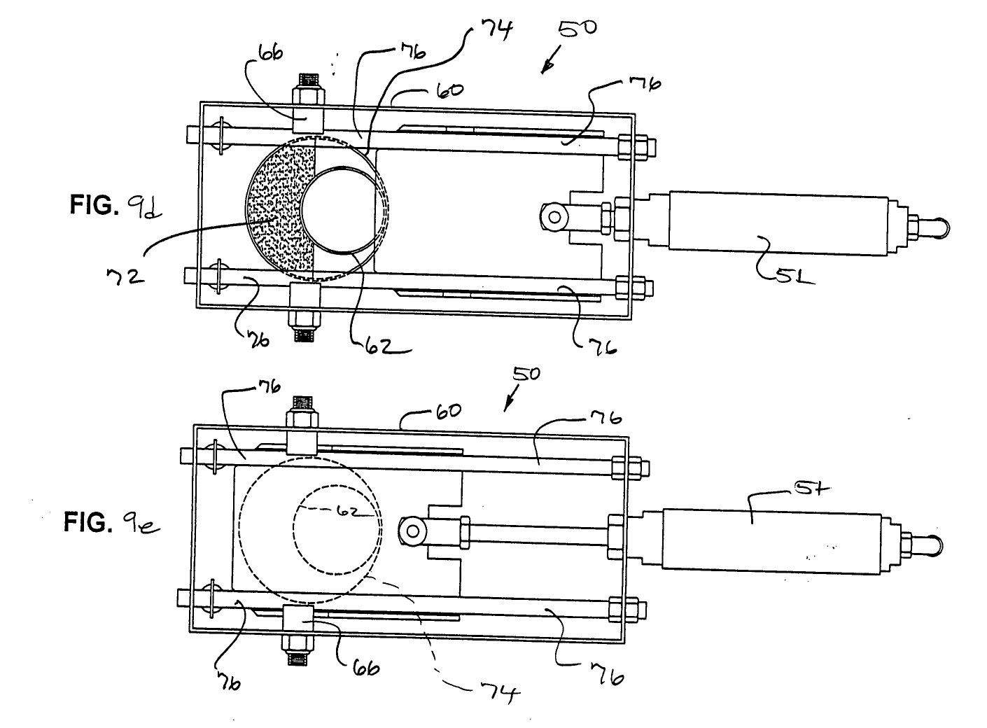

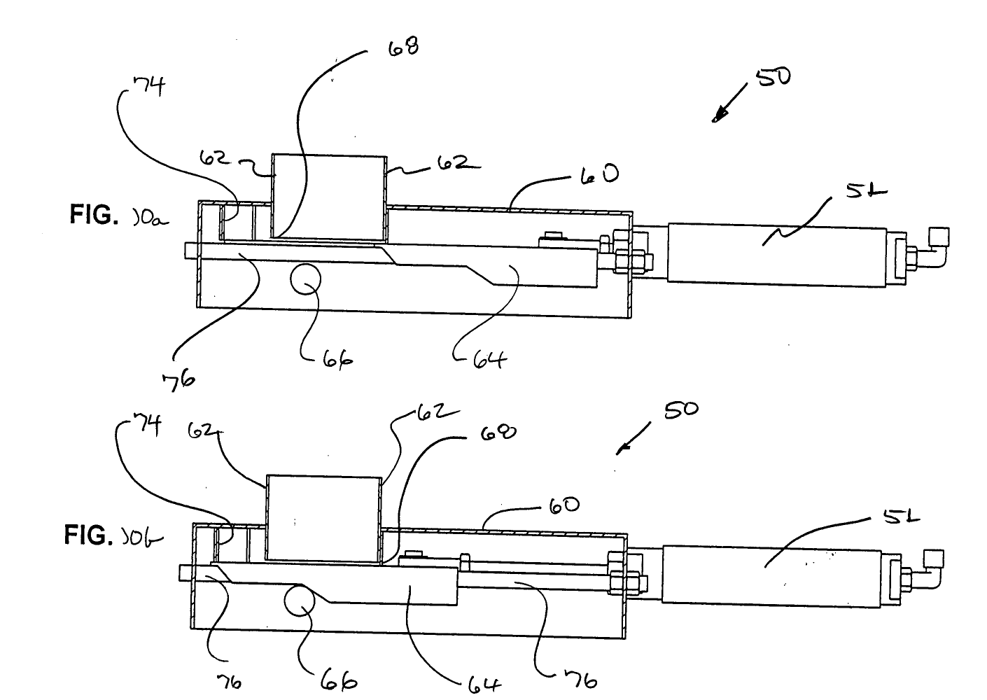

FIGS. 9a through 9e illustrate that scraper 72 may be placed in an alternative location. As shown in FIGS. 9a through 9e, a guard 74 in the shape of a ring may be utilized. In FIGS. 9a through 9e, guard 74 is a circular ring which is larger is diameter than discharge orifice 68. Guard 74 and discharge orifice 68 may tangentially share a common point on their circumference with guard 74 surrounding discharge orifice 68. Scraper 72 is between discharge orifice 68 and guard 74 and preferably extends below discharge orifice 68 to facilitate clearance of any resin granules as plate 64 closes to occlude intake conduit 62 of valve 50.

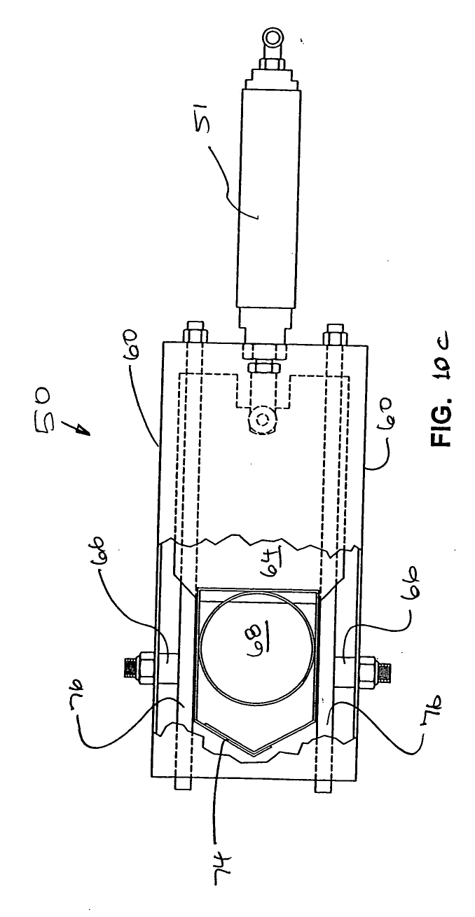

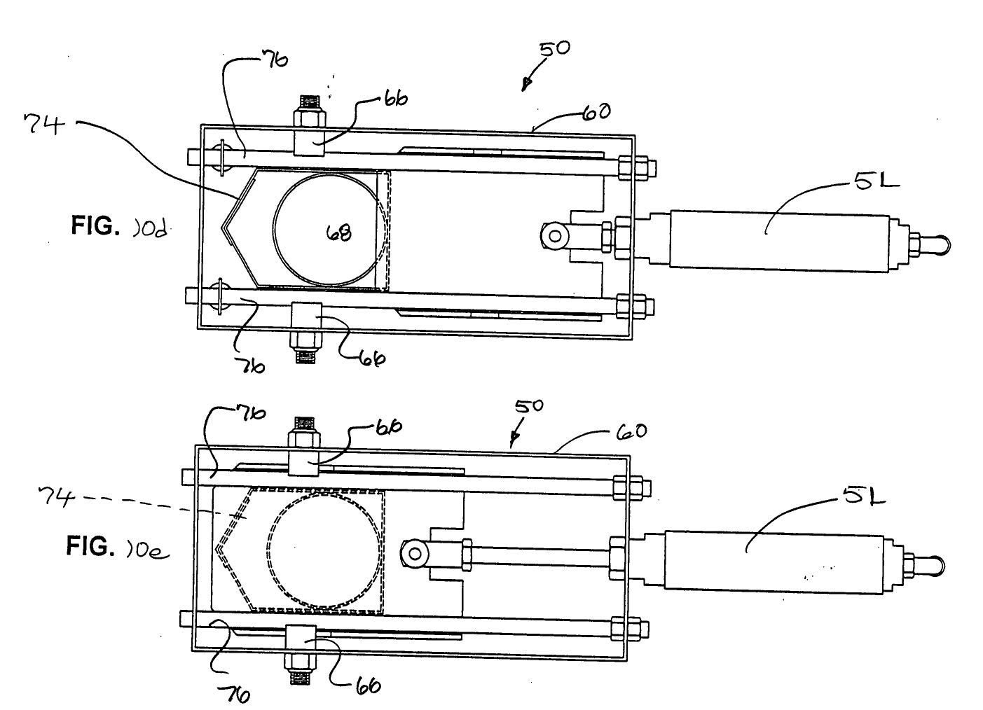

FIGS. 10a-10e illustrate yet another embodiment of granular material flow control valve 50. In this embodiment, guard 74 is shaped like an irregular pentagon, having two adjacent ninety (90) degree angles. However, unlike as previously described respecting FIGS. 9a through 9e, the function of scraper 72 is performed by guard 74, serving as a scraper receptacle receiving granular material adhering to plate 64, in addition to providing a guard about discharge orifice 68 defining a terminus of intake conduit 62. The longitudinally elongated edges of guard 74 help to remove granules as plate 64 sides to occlude intake conduit 62, preventing the passage therethrough of granular material when granular material flow control valve 50 is in closed position.

Positioning, presence or absence, and/or shape of guard 74 is not limited to the three embodiments discussed above and illustrated in the drawings. Similarly, scraper 72 may be positioned in any suitable matter to facilitate removal of granules from closure plate 64, as closure plate 64 is urged into the closed position.

Modifications, variations and equivalent arrangements which may occur to one skilled in the art should be considered to be within the scope of the invention.

1. A method for supplying plastics-related granular material to a plurality of receptacles for subsequent processing, such as by molding or extrusion, comprising:
a. applying a vacuum to granules of material in a supply depot to draw a granule stream therefrom;
b. vacuum drawing said stream past sequentially positioned individual receptacles of said plurality of receptacles; and
c. stripping granules from said stream for supply of said plurality of receptacles by passing said stream along a protuberance.

2. The method of claim 1, wherein stripping comprises diverting granules from said stream into one or more of said individual receptacles by passing said stream along a collection of transverse protuberances positioned proximate to downwardly directed granule passageways leading to said receptacles.

3. The method of claim 2, wherein stripping comprises mechanically diverting said granules.

4. The method of claim 2, wherein diverting comprises passing said stream along said transverse protuberances.

5. The method of claim 2, wherein there is one protuberance for each receptacle.

6. The method of claim 2, wherein there are a plurality of protuberances for at least one receptacle.

7. The method of claim 1, comprising drawing said stream concurrently past the receptacles of said plurality of receptacles.

8. The method of claim 7, wherein said granular material, reaching a predetermined level at a selected measuring station, is stripped from said stream.

9. The method of claim 1, comprising opening all of the plurality of receptacles concurrently thereby permitting downward flow of granular material therefrom into a collection means for subsequent processing.

10. The method of claim 1, comprising halting application of vacuum when granular material conveyed by said granular stream has reached a predetermined level at a selected measuring station.

11. The method of claim 1, in which all of said receptacles are simultaneously filed until reaching capacity regardless of receptacle capacity or material level requirement at a given receptacle.

12. The method of claim 1, comprising repeating steps “a”, “b” and “c” at a preselected time interval.

13. The method of claim 1, comprising collecting from said stream granules remaining therein after said stripping has been completed.

14. The method of claim 13, comprising collecting from said stream granules remaining therein after passage of said stream by the last of the plurality of receptacles.

15. The method of claim 13, comprising reintroducing said collected remaining granules into said stream at a position upstream of a first one of said protuberances.

16. The method of claim 13, comprising reintroducing said collected remaining granules into said stream drawn from said supply depot.

17. The method of claim 16, comprising halting application of said vacuum to a valve flap separating said excess material from a conduit through which said stream passes, thereby permitting said valve flap to open responsively to weight of said process material bearing thereon for downstream passage and joinder with said stream drawn from said depot.

18. A method for supplying plastics-related granular material to a plurality of receptacles, comprising:
a. pneumatically circulating a stream of said granular material around a loop in pneumatic communication with said plurality of receptacles; and
b. diverting granules from said stream for passage into at least two of said plurality of receptacles concurrently.

19. The method of claim 18, wherein diverting comprises mechanically diverting granular material from said stream for passage into at least two of said plurality of receptacles concurrently.

20. The method of claim 18, wherein pneumatically circulating comprises circulating the stream around a closed loop.

21. The method of claim 18, comprising diverting granules from said stream for passage into at least two of said plurality of receptacles concurrently until granular material from said stream has reached a predetermined level at a preselected location communicating with said loop.

22. A method for filling a plurality of receptacles with plastics-related granular material from a remote storage location having no operable necessity for any of an electrical connection between said plurality of receptacles and said remote storage location, receptacle level and weight sensors, and electrically operable receptacles, the method comprising:
a. pneumatically conveying a stream of said granular material from said remote storage location through a conduit communicating with said receptacles at discrete locations; and
b. diverting granules from said stream concurrently into said receptacles until all of said communicating receptacles are sufficiently filled.

23. A method for wirelessly periodically concurrently filling a plurality of receptacles of optionally differing size with plastics-related granular material for subsequent processing, such as by molding or extrusion, comprising:
a. applying a vacuum to granules of material in a supply depot to draw a granule stream therefrom into a conduit;
b. vacuum drawing said stream through a closed loop formed of said conduit and passing sequentially positioned individual receptacles of said plurality of receptacles connected to said closed loop; and
c. stripping granules from said stream for supply of said plurality of receptacles by passing said stream along protuberances extending into said closed loop.

24. A method for supplying plastics-related granular material to a plurality of receptacles for subsequent processing, such as by molding or extrusion, comprising:
a. pneumatically conveying a granular stream past sequentially positioned apertures each leading to an individual receptacle of the plurality of receptacles; and
b. stripping granules from said stream for conveyance through said apertures to said plurality of receptacles.

25. The method of claim 24, comprising passing said stream along a protuberance positioned substantially transversely to encounter granules traveling in said stream.

26. Wireless apparatus for supplying plastics-related granular material to a plurality of receptacles for subsequent processing, such as molding or extrusion, comprising:
a. a depot for holding said granular material to be supplied;
b. a pneumatic pump;
c. a conduit, connecting said depot with said pump for pneumatically-powered flow of said granular material therethrough from said depot to said pump, and including a plurality of apertures therein for delivery of said granular material therethrough from said conduit to the plurality of receptacles;
d. means for strippingly deflecting granular material flowing within said conduit into said apertures;
e. a collector, connected to said conduit upstream of said pump for collecting granular material which has flowed through said conduit and passed said plurality of apertures, and communicating with a portion of said conduit proximate said depot and upstream of said plurality of apertures, for recycling of said collected granular material into said conduit for flow therethrough together with granular material drawn from said depot;
f. means for detecting granular plastic resin material level in said collector and de-energizing said pump upon said granular material in said collector reaching a predetermined level; and
g. timer means for periodically energizing said pump, thereby drawing granular material through said conduit to supply said plurality of receptacles.

27. Apparatus of claim 26, wherein said pump comprises a vacuum pump.

28. Apparatus of claim 26, wherein each of said plurality of apertures comprises a lateral aperture.

29. Apparatus of claim 28, wherein each lateral aperture opens downwardly.

30. Apparatus of claim 26 wherein, the means for strippingly deflecting granular material comprises a plurality of protuberances, each of the plurality of protuberances associated with one of the plurality of apertures and extending transversely into said conduit.

31. Wireless vacuum powered apparatus for supplying a plurality of plastics-related processing machines with plastics-related granular material, comprising:
a. a depot for holding a supply of said granular plastic resin material;
b. a collector for receiving and recycling granular material conveyed from said depot and bypassing said processing machines;
c. a loop conduit leading from said depot and returning to said collector, with said collector communicating with said depot to close said loop conduit, said loop conduit having a central portion passing in proximity to said processing machines; and
d. a plurality of connectors along said loop conduit for directionally diverting said granular material for transport to said processing machines.

32. Apparatus of claim 31, wherein said connectors comprise “T-type” connectors, extend into said loop conduit, and downwardly divert granular material flowing through the loop conduit to respective ones of said processing machines.

33. An endless conduit loop for pneumatic conveyance of plastics-related granular material to plastics-related processing machines, comprising:
a. a depot for housing a supply of said granular material;
b. a collector defining a pair of fluidically connected chambers for respectively collecting from and discharging into said conduit loop granular material conveyed via said conduit loop from said depot which has bypassed said processing machines; and
c. means in said conduit loop for divertingly transporting to receptacles for delivery to said processing machines granular material flowing through said conduit loop.

34. The conduit loop of claim 33 wherein said loop further comprises pneumatic means for drawing vacuum in said loop adjacent to said second chamber thereby to suck granular plastic material from said first chamber and along said loop for delivery of at least a portion of said material to said processing machines, with residual granular plastic material entering said second chamber for storage therein and subsequent delivery to said first chamber for recycling through said loop.

35. The loop of claim 33 further comprising a valve between said fluidically connected chambers for controlling flow of granular resin material from said receiving chamber into said discharging chamber responsive to vacuum drawn in said loop.

36. The conduit loop of claim 33 wherein pneumatic conveyance is under vacuum and said loop further comprises means for drawing vacuum in said loop at said discharging chamber thereby to draw such granular plastic resin material from said receiving chamber and along said loop for delivery of at least a portion of said granular plastic resin material to said processing machines, residual granular plastic material entering said receiving chamber being stored therein and subsequently delivered to said discharging chamber for recycling through said loop.

37. Apparatus for supplying plastics-related granular material to a plurality of receptacles for subsequent processing such as molding or extrusion, comprising:
a. a reservoir for holding said granular material to be supplied;
b. a vacuum pump;
c. a conduit connecting the reservoir with said vacuum pump for flow of said granular material therethrough and including at least one lateral aperture therein for delivery of said granular material from said conduit to at least one of said plurality of receptacles; and
d. at least one protuberance extending transversely into said conduit from said at least one lateral aperture for strippingly deflecting granules flowing within said conduit from said material flow for downward passage through said at least one aperture.

38. Apparatus for supplying a plurality of plastics-related processing machines, comprising:
a. a first chamber for housing a supply of said plastics-related granular material;
b. a second chamber for receiving and discharging into said first chamber plastics-related granular material which has traversed a conduit loop and bypassed said plastic material processing machines; and
c. a plurality of connectors in said conduit loop for diverting and permitting downwardly gravity powered transport of plastic resin material flowing through said conduit loop to said processing machines.

39. Apparatus for supplying a plurality of plastics-related processing machines with plastics-related granular material, comprising:
a. a first chamber for housing a supply of said granular material;
b. a second chamber for receiving and discharging into said first chamber granular material conveyed from said supply and bypassing said processing machines;
c. a loop conduit connecting said first and second chambers and intermediately thereof passing in proximity to said processing machines; and
d. a plurality of connectors along said loop conduit for diverting and downwardly transporting said granular material flowing through said loop conduit to said processing machines.

40. Apparatus of claim 39, comprising:
a. a pump for drawing subatmospheric pressure in said loop conduit to convey said granular material therethrough, wherein first and second chambers are respectively lower and upper subchambers of a common housing communicating with one another; and
b. a pneumatically actuated valve separating said subchambers and closing to preclude gravity from inducing material to flow from said upper to said lower chamber responsively to vacuum drawn in said upper chamber, said upper and lower chambers connecting to said loop conduit proximate respective ends thereof, said upper chamber connecting to said loop conduit more proximately said pump than said lower chamber, said valve opening responsively to at least one of the presence of an amount of granular material in said upper chamber and whenever said pump is not operating.

41. Apparatus of claim 40 further comprising means for sensing when a predetermined amount of granular material has occupied said upper chamber.

42. Apparatus of claim 40, wherein said lower chamber empties downwardly into said loop conduit proximate a juncture of said loop conduit with a depot of granulated material, thereby to recycle granular material from said lower chamber past said connectors for supply to said process machines prior to previously uncirculated granulated material being drawn from the depot.

43. A valve comprising:
a. a body;
b. an intake conduit, connected to said body for flow therein of material;
c. a closure plate movable between intake conduit open and closed positions and movable transversely with respect to but axially spaced from a discharge end of said intake conduit;
d. a pneumatic piston-cylinder combination connected to said body, for moving said closure plate between said open and closed positions;
e. a cam connected to said body, urging said closure plate towards the discharge end of said conduit as said closure plate moves from said open position towards said closed position; and
f. a removal means positioned for sliding travel of a leading edge of said closure plate therealong to interferingly contact and thereby remove granules of material adhering to said plate.

44. The valve of claim 43, wherein the portion of said closure plate adapted to occlude said discharge end comprises a planar portion.

45. The valve of claim 43, comprising cam-runners extending parallel with a direction of plate motion and extending transversely to the portion of the plate adapted to occlude said discharge end.

46. The valve of claim 44, wherein said cam contacts said cam-runners and is adapted to urge said closure plate against said discharge end with increasing force as said closure plate moves across said discharge end

47. The valve of claim 43, comprising a deformable scraper, adjacent to at least one of an inner surface of the conduit and an outer surface of the conduit, and having a bottom surface adapted to be upwardly deformed by the closure plate, thereby facilitating vacuum seal.

48. The valve of claim 43, comprising a guard positioned within said body and proximate said intake conduit.

49. The valve of claim 48, wherein a portion of the closure plate overlies said guard and is planar.

50. The valve of claim 48, comprising a deformable scraper, adjacent to at least one of an inner surface of the conduit and an outer surface of the conduit, and having a bottom surface adapted to be upwardly deformed

51. The valve of claim 50, wherein said bottom surface is canted with respect to the planar portion of the closure plate.

52. A method for effectuating a substantially air-tight seal and stopping flow of granular material out a discharge end of an intake conduit, comprising:
a. moving a closure plate from intake conduit open position to a closed position, by moving the plate transversely with respect to but axially spaced from the discharge;
b. positioning removal means for sliding travel of a leading edge of the closure plate therealong to interferingly contact and thereby remove granules of material adhering to said plate; and
c. urging with a cam said closure plate towards the discharge end of said conduit as said closure plate moves from said open position towards said closed position.

53. The method of claim 52, comprising occluding said discharge end with a planar portion of said closure plate.

54. The method of claim 52, comprising sliding cam-runners over the cam that extend parallel with a direction of plate motion and extend transversely to the portion of the plate adapted to occlude said discharge end.

55. The method of claim 54, comprising urging said cam in contact with said cam-runners to urge said closure plate against said discharge end with increasing force as said closure plate moves across said discharge end.

56. The method of claim 52, comprising positioning a deformable scraper adjacent to at least one of an inner surface of the conduit and an outer surface of the conduit, said deformable scraper having a bottom surface adapted to be upwardly deformed by the closure plate, thereby facilitating vacuum seal.

57. The method of claim 52, comprising positioning a guard outside said intake conduit and proximate to said intake conduit.

58. The method of claim 57, wherein a portion of the closure plate overlies said guard and is planar.

59. The method of claim 57, comprising positioning a deformable scraper adjacent to at least one of an inner surface of the conduit and an outer surface of the conduit, said deformable scraper having a bottom surface adapted to be upwardly deformed by the closure plate, thereby facilitating vacuum seal.

60. The method of claim 59, wherein said bottom surface is canted with respect to a planar portion of the closure plate.
